(19) United States
(12) Patent Application Publication
(10) Pub. No.: US 2015/0131295 A1
(43) Pub. Date: May 14, 2015

(54) THIN-FILM COATING FOR IMPROVED OUTDOOR LED REFLECTORS

(71) Applicant: GE Lighting Solutions, LLC, East Cleveland, OH (US)

(72) Inventors: Mark J. MAYER, Sagamore Hills, OH (US); Dengke CAI, Mayfield Heights, OH (US); Xiaomei LOU, East Cleveland, OH (US); Koushik SAHA, Brunswick, OH (US); Gabriel Michael SMITH, Cleveland, OH (US); Benjamin James WARD, Cleveland, OH (US)

(73) Assignee: GE Lighting Solutions, LLC, East Cleveland, OH (US)

(21) Appl. No.: 14/077,323

(22) Filed: Nov. 12, 2013

(51) Int. Cl. F21V 7/22; F21K 99/00

(52) U.S. Cl. CPC F21V 7/22; F21K 9/50; F21K 9/90; F21Y 2101/02
USPC 362/296.03; 362/341; 362/296.04; 427/162

(57) ABSTRACT

Provided is a light emitting diode (LED) reflector assembly. The reflector assembly includes a metallic substrate, a porcelain coating overlaying a metallic substrate, and a multi-layer thin-film layer overlaying the porcelain coating.

### TECHNICAL FIELD

The present invention relates generally to outdoor light emitting diode (LED) reflectors. More specifically, the present invention relates to improved techniques for maximizing the reflectivity of outdoor LED reflectors.

### BACKGROUND

Technologies used in the design and manufacture of outdoor lighting fixtures have rapidly evolved in recent years. Advancements in these technologies have spawned not only new types of lighting fixtures, or luminaires, but have facilitated optimization of these fixtures for a variety of outdoor lighting applications.

Outdoor luminaires typically include a light source, a lens, and/or a reflector. The light source can include, for example, incandescent lamps, high intensity discharge (HID) lamps, halogens, and LEDs, to name a few.

Incandescent lamps and HID lamps are widely used in highway and roadway lighting applications to provide illumination for walkways and roadways. Halogens and LEDs, for example, are more widely used in retail settings, hospitality environments, museums, and homes—providing everything from spotlights to floodlighting.

The reflector, lens, and shielding associated with outdoor luminaires typically define the light distribution pattern. More particularly, reflector optics can be critically important in defining this distribution pattern. For example, a reflector's shape and the reflectivity of its surface largely define its optical characteristics. Reflectors surfaces are coated with suitably reflective materials that not only enhance the light source's distribution pattern, but can also increase light output ratios (LORs).

Many conventional LED outdoor luminaire reflector are constructed of plastic, coated with aluminum. These aluminum coated plastic reflectors, however, have several shortcomings. For example, the conventional aluminum coated reflectors have lower and non-uniform reflectivity with respect to the spectrum of the reflected light. Aluminum coatings can also be prone to performance losses due to environmental exposure.

The example above, the aluminum coating is applied to the reflector using a standard metallization process. In some instances, this metallization process has its own deficiencies. For example, the aluminum metallization process can create non-uniform thickness in application of the aluminum coating to the plastic substrate, depending on line-of-sight from the aluminum evaporation source to the surface of the reflector.

Also, plastic reflectors can be degraded and deformed by exposure to high temperature, as would be seen in an LED luminaire. Adhesion of the aluminum can also be adversely affected by a coefficient of thermal expansion (CTE) mismatch between the aluminum and the plastic reflector substrate.

Others have explored using silver metallizing to improve reflectivity. Silver, however, has additional shortcomings and fails to resolve the shortcomings noted above.

### SUMMARY OF THE EMBODIMENTS

Given the aforementioned deficiencies, a need exists for more effective systems and processes for coating outdoor LED luminaire reflectors. A need also exists for methods and systems that enable the re-tooling of conventional shaped reflectors in metal and facilitate coating these reflectors with porcelain or enamel with a final multi-layer constructive interference thin-film.

In at least one embodiment, the present invention provides an LED reflector. The reflector includes a metallic substrate, a porcelain, vitreous, or ceramic coating overlaying the metallic substrate, and a multi-layer thin-film layer overlaying the porcelain, vitreous, or ceramic coating.

Embodiments of the present invention enable reuse of existing shaped LED reflector designs in metal. Surface roughness (Ra) or thickness non-uniformities of the metal substrate can be smoothed and minimized by applying a high temperature stable porcelain or enamel coating to the substrate. A final multi-layer constructive interference thin-film is applied to the porcelain or enamel coating.

The embodiments provide several advantages, including improving reflectivity to up to 99%. The advantages also include higher temperature reliability and an ability to spectrally tune and optimize the reflector. Additional advantages include the use of turn-key reflector designs through application of existing technology and infrastructure to improve resistance to humidity and oxidation. The technology constructed in accordance with the embodiments is not line-of-sight dependent—enabling the stacking of reflectors in coating chambers.

Further features and advantages, as well as the structure and operation of various embodiments, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS

Exemplary embodiments may take form in various components and arrangements of components. Exemplary embodiments are illustrated in the accompanying drawings, throughout which like reference numerals may indicate corresponding or similar parts in the various figures. The drawings are only for purposes of illustrating preferred embodiments and are not to be construed as limiting the invention. Given the following enabling description of the drawings, the novel aspects of the present invention should become evident to a person of ordinary skill in the art.

FIG. 1 is an illustration of a conventional LED reflector assembly constructed from a plastic substrate.

FIG. 2 is an illustration of an LED lamp assembly constructed from a glass substrate.

FIG. 3 is an illustration of a cross-section of coating layers that form the reflective surface of an LED lamp assembly in accordance with embodiments of the present invention.

FIG. 4 is a flow chart of an exemplary method of practicing an embodiment of the present invention.

### DETAILED DESCRIPTION OF THE EMBODIMENTS

While exemplary embodiments are described herein with illustrative embodiments for particular applications, it should be understood that the invention is not limited thereto. Those skilled in the art with access to the teachings provided herein will recognize additional modifications, applications, and embodiments within the scope thereof and additional fields in which the multi-reflector design described herein would be of significant utility.

FIG. 1 is an illustration of a conventional LED reflector assembly 100 commonly used in outdoor lighting applications. The reflector assembly 100 includes a plastic substrate (not shown) coated with a reflective aluminum surface 102. During manufacture, the plastic substrate can be injection molded into a mirror-like finish. The aluminum, or silver, can be deposited directly on the plastic substrate. As noted above, however, aluminum coatings used on plastic generally produces lower and non-uniform light reflectivity. The reflector assembly 100 is also subject to performance losses due to environmental factors such as extreme heat and cold.

When used as a coating material, aluminum provides only about 80% reflectivity. The highest reflectivity, however, can be achieved by using a multi-layer thin-film coating stack. Multi-layer thin-film coatings typically achieve greater than 98% reflectivity.

Multilayer thin film stacks can be composed of “soft” and “hard” coating materials. Examples of “soft” materials are transparent materials such as ZnS and MgF, while “hard” materials are generally transparent metal oxides such as TiO2, Ta2O5, Nb2O5, SiO2, among many others. A benefit of using a multilayer thin-film stack composed of “hard” coating compounds is the chemical stability of the coating. “Hard” thin-film coatings are virtually impervious to the elements.

As such, a thin-film stack composed of “hard” coating compounds is highly desirable for use in outdoor lighting fixtures given the severe elements outdoor lighting fixtures are exposed to. Although silver, for example, is capable of achieving high levels of reflectivity, silver is also extremely vulnerable to the elements. For example, silver is can be adversely affected by oxygen, humidity, and mildly acidic environments. Unlike multi-layer thin-film, vulnerabilities to the elements can cause silver to lose some or all of its reflectivity.

Thin-film coatings, however, cannot be deposited on plastic substrates of the type used in the reflective aluminum surface 102. Thin-film stacks are generally only deposited on glass, quartz, or similar substrates or in some cases on a specular-smooth metal surface. For outdoor LED fixtures, the reflectors can have very complicated shapes and can become relatively large. These complicated shapes make it difficult to form the reflectors from glass due limitations of glass processing to create acute angles. For example, the tooling for construction of glass molds for these reflectors would be cost prohibitive even though glass is relatively inexpensive. Several designs exist of reflectors made from glass substrates coated with a thin-film multilayer stack.

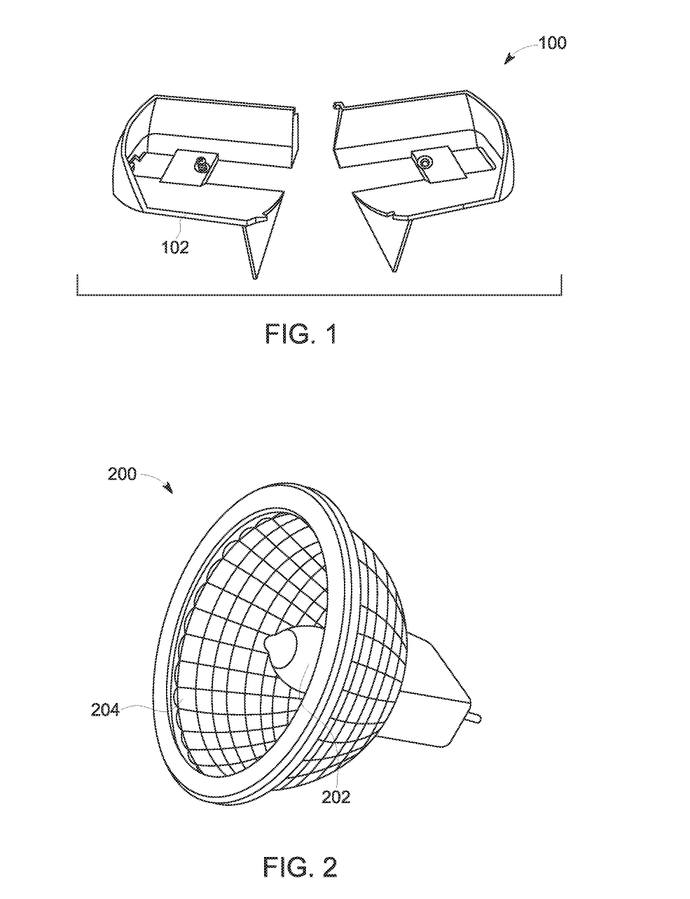

FIG. 2 is an illustration of an outdoor LED lamp assembly 200 typically used in gardening applications. The outdoor LED assembly 200 includes a light source 202 and a reflective surface 204. The reflective surface 204 coats a glass substrate (not shown). The light source 202 is typically a halogen or LED lamp. In outdoor lighting applications, LEDs are increasingly preferred over other light sources due to their efficiencies and meantime between failure rates.

The reflective surface 204 is formed from a thin-film material deposited on the underlying glass substrate. In the exemplary LED reflector assembly 200, the thin-film coating behaves as a dichroic reflector. That is, although the reflector assembly 200 is configured to reflect visible light, it does not reflect infrared light energy. More specifically, thin-film coatings used in dichroic reflector applications can be tuned to selectively reflect some wavelengths. At the same time, this selectively permits the simultaneous rejection of other wavelengths.

Conventional reflector systems formed of glass substrates, such as the reflector assembly 200, are easy and inexpensive to manufacture given the wide availability of the raw materials. An additional advantage of glass substrates is that when glass reaches the molten state during manufacture, and is allowed to cool, a reflective glassy surface inherently emerges. Additionally, glass melts at a fairly high temperature which is necessary because the thin-film coating is applied in a heated reactor. When the reactor heats up, it achieves temperatures between 400 to 600° C. However, a significant shortcoming of glass is its unmalleability, which can render it unable to achieve reflector geometry requirements for some outdoor lighting applications.

Other materials exist that would be of a sufficiently high temperature and also have a higher malleability. By way of example, and not limitation, such materials can include steel or aluminum die-cast. Many other suitable materials also exist. These other materials, though more easily formed into complex shapes than glass, lack the reflective surface finish of glass.

Referring back to FIG. 1, before aluminum and silver can be used to coat the plastic substrate, typically a base coating must be sprayed on that self-levels into a liquid. This solution is dried using known drying techniques to provide a glossy surface.

The spray-on base coats, in a manner similar to plastic, cannot survive high heat. Therefore, it would be virtually impossible to take steel reflectors, then spray on the lacquer base coat, and provide the thin-film coating. This is not possible because as soon as the temperature exceeds about a few hundred degrees C., the base coating will burn off, leaving the surface worse than it was initially. Embodiments of the present invention overcome this deficiency.

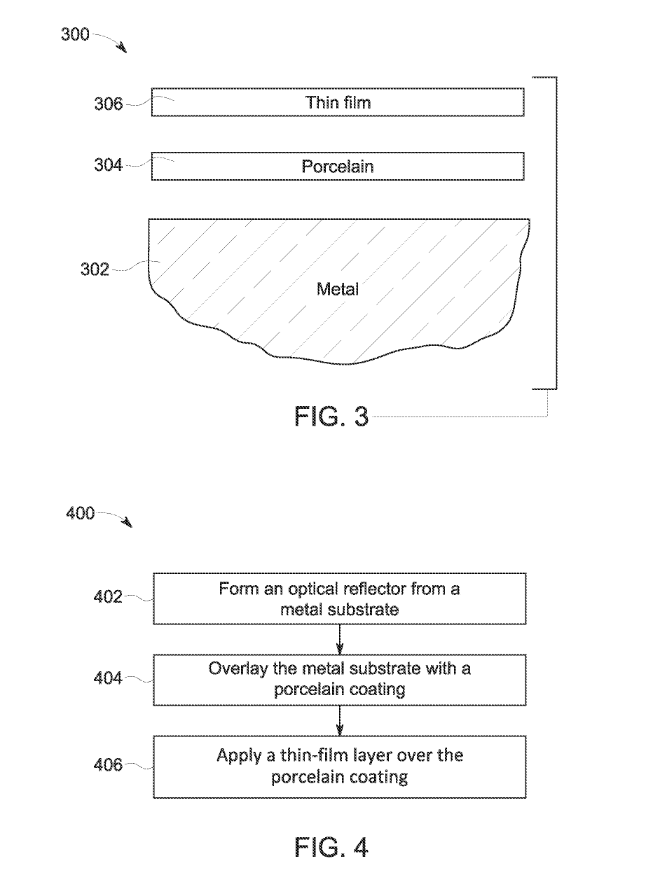

The illustrated embodiments provide a reflector surface constructed of a metal substrate. By way of example, suitable metals can include steel, aluminum, silver, or die-cast, to name a few. The metal substrate is then coated with selected porcelain or similar material, e.g. GE Lighting's proprietary ALGLAS coating. This process is illustrated in FIG. 3.

FIG. 3 is an illustration of a cross-section of coating layers 300 that form a reflective surface for an LED lamp assembly in accordance with the embodiments.

In FIG. 3, the reflector surface includes a metal substrate 302 coated with a base layer 304 of porcelain, glass or ceramic. The base layer 304 serves as a glass-like coating on the metal substrate 302. A multi-layer thin-film 306 coats the porcelain, or porcelain ceramic layer 304. The metal substrate 302, the porcelain coating 304, and the thin-film coating 306 provide the inherent performance benefits of both reflectivity and element survivability.

The thin-film coating 306 can be formed of any highly smooth and low Ra, and high temperature stable base layer 304. As understood by those of skill in the art, the multi-layer thin-film coating 306 is composed of alternating high- and low-refractive index layers to reflect and refract light. The layer thicknesses are chosen in such a manner as to generate constructive interference for desired wavelengths of light, most often by creating Quarter Wave Stacks (QWS).

A QWS is the most efficient way to reflect light at a given wavelength, as the optical thickness of the layer is ¼ the wavelength of the light which then generates constructive interference upon reflection of the light at the layer interfaces. FIG. 4 is a flow chart of an exemplary method 400 of practicing an embodiment of the present invention. In the method 400, and optical reflector is formed from a metal substrate at step 402. In step 404, the metal substrate is covered with a porcelain coating. A thin-film layer is applied to the porcelain coating in step 406.

In the embodiments of the present invention, different porcelain formulations can be applied depending on the specific type of metal used. For example, in the embodiments, one porcelain or glass formulation can be used for steel, while another formulation might be more suitable for aluminum. Different formulations account for the fact that the porcelain or glass may or may not fire at a higher temperature than the applicable metal used in the substrate.

Embodiments of the present invention enable retooling of existing shaped LED reflectors to form a metal substrate. Surface roughness or thickness non-uniformities of the metal substrate are minimized by application of a high temperature stable coating to the substrate. A final multi-layer constructive interference thin-film is applied to the porcelain coating.

Alternative embodiments, examples, and modifications which would still be encompassed by the invention may be made by those skilled in the art, particularly in light of the foregoing teachings. Further, it should be understood that the terminology used to describe the invention is intended to be in the nature of words of description rather than of limitation.

Those skilled in the art will also appreciate that various adaptations and modifications of the preferred and alternative embodiments described above can be configured without departing from the scope and spirit of the invention. Therefore, it is to be understood that, within the scope of the appended claims, the invention may be practiced other than as specifically described herein.

We claim:

1. An optical reflector, comprising:
a metal substrate;
a coating overlaying the metal substrate, the coating being formed of at least one from the group including porcelain, glass, and ceramic; and
a thin-film layer overlaying coating.

2. The optical reflector of claim 1, wherein the optical reflector is a light emitting diode (LED).

3. The optical reflector of claim 2, wherein the LED is a light source in a light assembly.

4. The optical reflector of claim 1, wherein the metal includes at least one from the group including steel, aluminum, and die-cast alloys.

5. The optical reflector of claim 1, wherein the thin-film layer is formed of a multilayer.

6. The optical reflector of claim 5, wherein at least one of the multiple layers includes at least one dielectric layer,

7. The optical reflector of claim 1, wherein the layers of the thin-film stack are dielectric materials.

8. The optical reflector of claim 7, wherein the thin-film layer is a multilayer stack designed to generate constructive interference of visible light.

9. The optical reflector of claim 1, wherein coating materials are applied to the reflector in a vacuum coating chamber.

10. The optical reflector of claim 1, wherein the thin-film layer includes dichroic properties.

11. A method of coating an optical reflector, comprising:
forming the optical reflector from a metal substrate;
overlaying the metal substrate with a coating formed of at least one from the group including porcelain, vitreous, and ceramic; and
applying a thin-film layer over the porcelain coating.

12. The method of claim 11, wherein the coating is applied via a high temperature coating process.

13. The method of claim 11, wherein the porcelain coating provides a glasslike finish to the metal substrate.

14. The method of claim 11, wherein the optical reflector is a light emitting diode (LED).

15. The method of claim 14, wherein the LED is a light source in a light assembly.

16. The method of claim 11, wherein the metal includes at least one from the group including steel, aluminum, and die-cast.

17. The method of claim 11, wherein the thin-film layer includes multiple layers.

18. The method of claim 17, wherein at least one of the multiple layers includes at least one dielectric layer,

19. The method of claim 1, wherein the thin-film layer is a dielectric material.
